(19) United States
(12) Patent Application Publication
(10) Pub. No.: US 2002/0164902 A1
(43) Pub. Date: Nov. 7, 2002

(54) Display unit

(75) Inventors: Ming-Shen Martin Sun, Hsinchu (TW); Guang Tau Sung, Taichung Hsien (TW); Kuo-Chung Lee, Yunlin Hsien (TW)

Correspondence Address: DARBY & DARBY P.C., Post Office Box 5257, New York, NY, 10150-5257, US

(73) Assignee: AU Optronics Corp.

(21) Appl. No.: 10/185,396

(22) Filed: Jun. 28, 2002

Related U.S. Application Data
(62) Division of application No. 09/950,166, filed on Sep. 10, 2001.

(30) Foreign Application Priority Data
Dec. 19, 2000 (TW) 89127254

(51) Int. Cl. H01R 13/58

(52) U.S. Cl. 439/605

(57) ABSTRACT

A display unit (2) comprises a case (20), a panel (21), a lamp (22), an intermediate (23) and a lead wire (24). The lamp (22) is placed next to the panel (21), and the lead wire (24) is electrically connected to the lamp (22) to form a conjunctive portion. The conjunctive portion is placed in a mold (3) and integrally covered with the intermediate (23). When the lead wire (24) is pulled by an abnormal or abrupt force, the majority of the force can be absorbed by the intermediate (23) pressed on the case (20), and the lead wire (24) can remain fixed to the lamp (22).

### BACKGROUND OF THE INVENTION

1. Field of the invention

This invention relates to a display unit. More particularly, this invention relates to a display unit provided with a lamp and a lead wire, which are connected and molded with an intermediate thereon.

2. Description of Prior Art

Referring to FIG. 1A and 1B FIG. 1A is a view showing a display structure 1 according to the prior art, and FIG. 1B is a top view of FIG. 1A.

In FIG. 1A, a display unit 1 comprises a case 10, a panel 11, a lamp 12 having two ports 121 (121) , two plastic sleeves 13 (13) and two lead wires 14 (14) , wherein the lead wires 14 (14) are respectively applied with high voltage and grounded. The panel 21 and the lamp 12 are received in the case 10, and the lamp 12 is placed next to the panel 21. The lamp 12 has two ports 121 (121) , and the lead wires 14 (14) are connected to the ports 121 (121).

In FIG. 1B, the plastic sleeve 13 covers the junction of the port 121 of the lamp 12 and the lead wires 14 which are connected, and the plastic sleeve 13 is used as a stopper placed against the case 20.

Referring to FIG. 2A and 2B, FIG. 2A is an enlarged view according to a region Z1 of FIG. 1B, and FIG. 2B is an exploded view according to FIG. 2A.

In FIG. 2B, the port 121 is extended from the lamp 12, and a hole 122 is formed on the end of the port 121. Another port 141 is formed on the end of the lead wire 14. The sleeve 13 is a hollow element provided with an L-shaped through hole 130 therein. The lead wire 14 is connected to the lamp 12 by plugging the port 141 to the hole 122 of the port 121 within the L-shaped through hole 130 of the sleeve 13. As the sleeve 13 is set on the port 121 of the lamp 12 and the port 141 of the wire 14, the sleeve 13 can be used as a stopper with its end 131 adjacent to the case 10.

FIG. 2C is a cross-sectional view according to FIG. 2A. Clearances 1214 exist between the sidewall of the L-shaped through hole 130 and the port 121 as well as between the sidewall of the L-shaped through hole 130 and the port 141. Once the lead wire 14 is pulled by an abnormal or abrupt force F, the force F is directly transmitted to the port 121 of the lamp 12, and the lead wire 14 is easily dislodged from the lamp 12 even if the sleeve 13 is pressed on the case 10.

### SUMMARY OF THE INVENTION

To solve the above problem, the primary object of this invention is to provide a method for forming a display unit. The display unit comprises a panel, a lamp having a first port and a lead wire having a second port connected to the first port to form a conjunctive portion. A mold is provided with a cavity and a riser. The conjunctive portion is placed in the cavity and a fluxed intermediate is injected into the cavity to integrally coat on the conjunctive portion.

### BRIEF DESCRIPTION OF THE DRAWINGS

The present invention can be more fully understood by reading the subsequent detailed description and examples with reference made to accompanying drawings in which:

FIG. 1A is a view showing a display structure (1) according to the prior art;

FIG. 1B is a top view of FIG. 1A;

FIG. 2A is an enlarged view according to a region (Z1) of FIG. 1B;

FIG. 2B is an exploded view according to FIG. 2A;

FIG. 2C is a cross-sectional view according to FIG. 2A;

FIG. 3A is a view showing a display unit (2) according to the present invention;

FIG. 3B is a top view of FIG. 3B;

FIG. 4 is an enlarged view according to a region (Z2) of FIG. 3B;

FIG. 5A is an exploded view according to FIG. 4;

FIG. 5B is a cross-sectional view showing the inner structure of a mold (3) which is provided with a cavity (31) and enclosed with part of the display unit (2); and

FIG. 5C is a cross-sectional view according to FIG. 4.

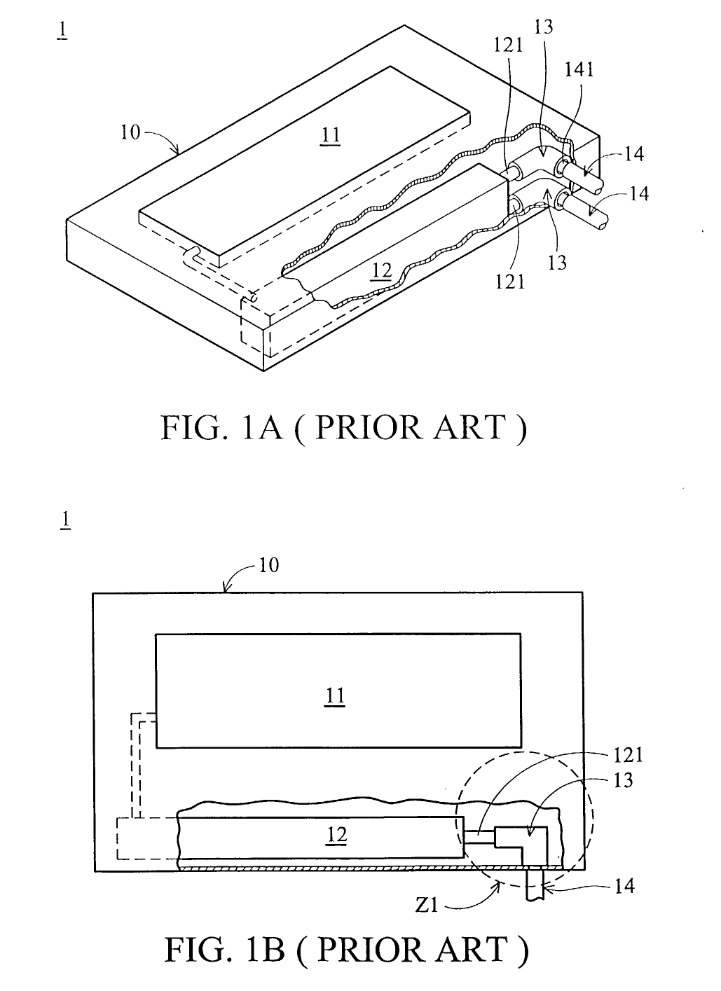

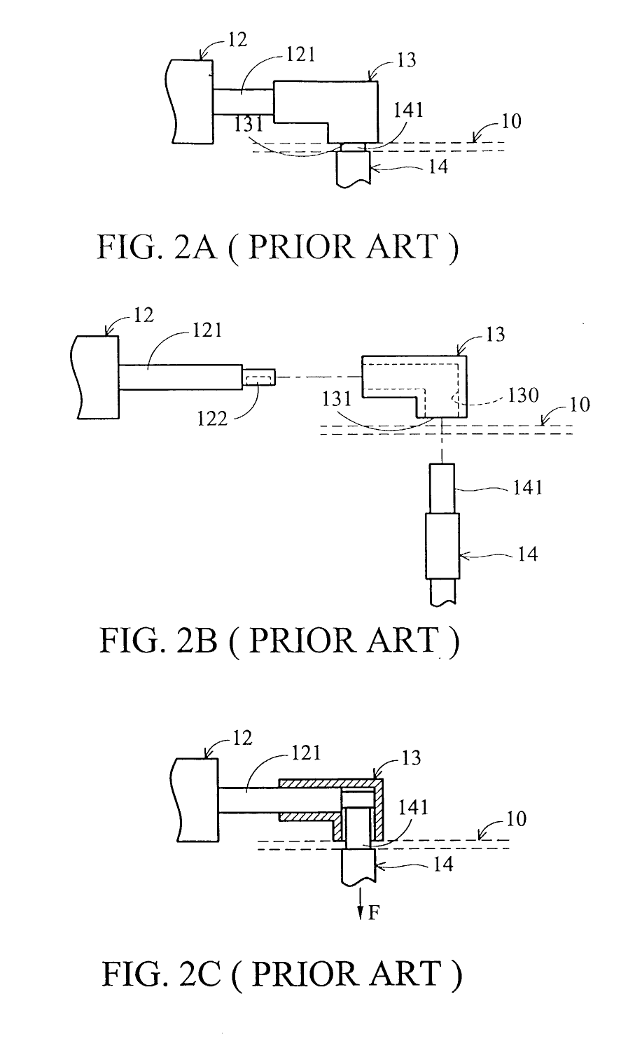

### DETAILED DESCRIPTION OF THE PREFERRED EMBODIMENTS

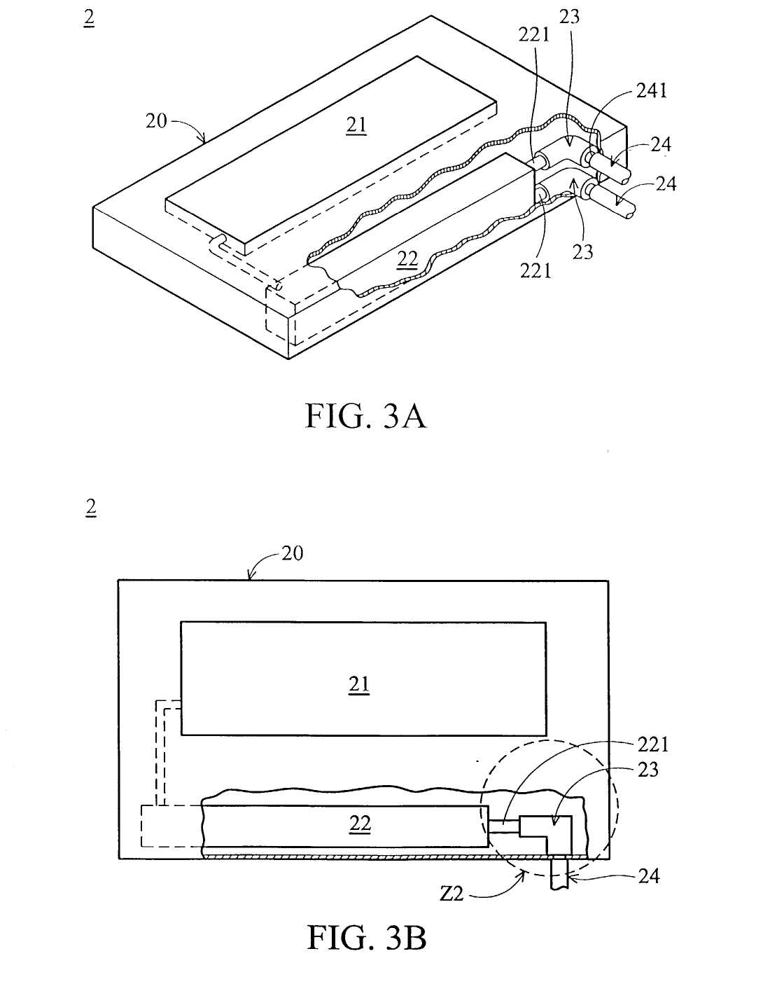

Referring to FIG. 3A and 3B, a display unit 2 comprises a case 20, a panel 21, a lamp 22 having two first ports 221 (221), two intermediate 23 and two lead wires 24 (24). The lamp 22 is placed next to the panel 21, and the lead wires 24 are electrically connected to the first ports 221 (221) of the lamp 22. One of the lead wires 24 (24) is applied with high voltage, and the other is grounded.

The intermediate 23 is preferably made of plastic material such as rubber, and the intermediate 23 is integrally formed on a conjunctive portion, which is a portion located at the intersection of the first port 221 of the lamp 22 and the lead wire 24. The first port 221 of the lamp 22 and the lead wire 24 are fixed together by the intermediate 23.

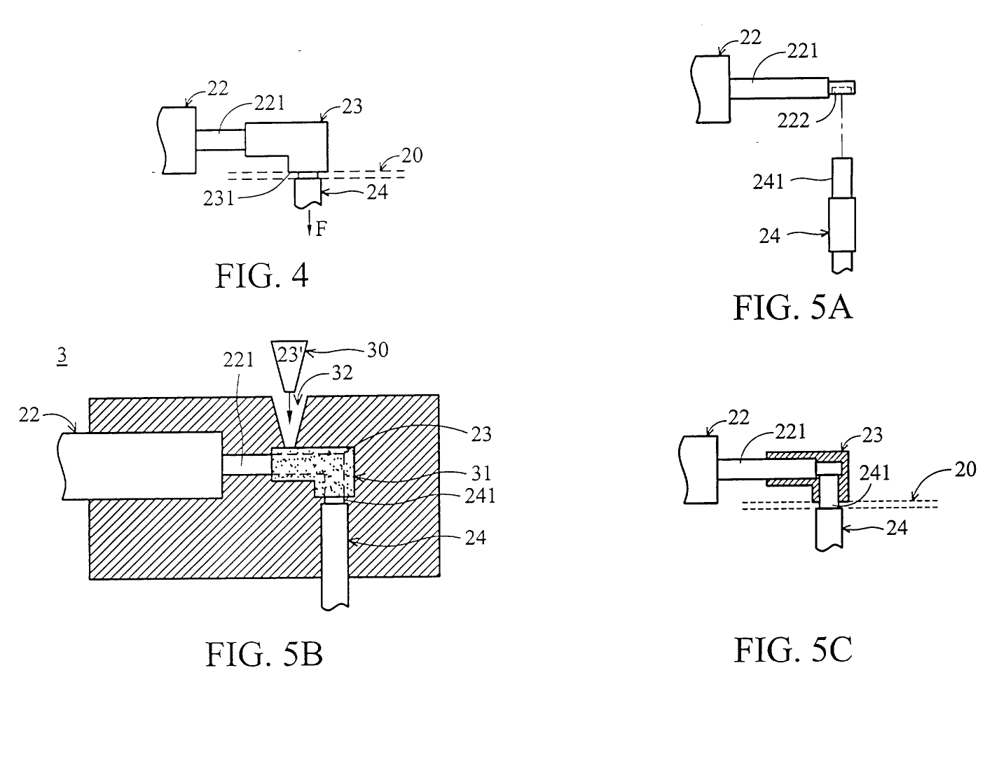

In FIG. 4, an enlarged view shows a region Z2 of FIG. 3B, and FIG. 5A is an exploded view according to FIG. 4 without the intermediate 23.

In FIG. 5A, the first port 221 extends from the main body of the lamp 22, and a hole 222 is formed on the free end of the first port 221. A second port 241 is formed on the end of the lead wire 24. The lead wire 24 is temporally connected to the lamp 22 by plugging the second port 241 to the hole 222 of the first port 221.

In FIG. 5B, a mold 3 is provided with a cavity 31 and a riser 32. The conjunctive portion of the first port 221 of the lamp 22 and the lead wire 24 is placed in the cavity 31. Then, a fluxed intermediate 23′ supplied by a feeder 30 is injected into the cavity 31 via the riser 32, and then the conjunctive portion is solidly covered with the intermediate 23 when the fluxed intermediate 23′ is condensed.

FIG. 5C is a cross-sectional view according to FIG. 4. The intermediate 23 is integrally formed on the first port 221 of the lamp 22 and the second port 241 of the lead wire 24. Referring again to FIG. 4, the intermediate 23 covered on the lamp 22 and the lead wire 24 is used as a stopper being placed adjacent to the case 20. Once the lead wire 24 is pulled by an abnormal or abrupt force F, the majority of the force F can be absorbed by intermediate 23, and the lead wire 24 can be fixedly connected to the lamp 22.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A display unit, comprising:
a panel;
a lamp disposed on the panel, having a first port;
a lead wire having a second port connected to the first port to form a conjunctive portion; and
an intermediate integrally formed on the conjunctive portion.

2. The display unit as claimed in claim 1, wherein the intermediate is formed by injection.

3. The display unit as claimed in claim 1, wherein the intermediate is made of plastic material.

4. The method for forming a display unit as claimed in claim 1, wherein the intermediate is made of rubber.

5. A method for forming a display unit, which comprises a lamp having a first port, a lead wire having a second port connected to the first port to form a conjunctive portion, comprising the steps of:
providing a mold formed with a cavity;
placing the conjunctive portion to the cavity;
injecting an intermediate into the cavity to coat the conjunctive portion.

6. The method for forming a display unit as claimed in claim 5, wherein the intermediate is formed by injection.

7. The method for forming a display unit as claimed in claim 5, wherein the intermediate is made of plastic material.

8. The method for forming a display unit as claimed in claim 5, wherein the intermediate is made of rubber.
